(19) United States
(12) Patent Application Publication
(10) Pub. No.: US 2020/0028281 A1
(43) Pub. Date: Jan. 23, 2020

(54) TERMINAL METAL FITTING AND TERMINAL-ATTACHED ELECTRIC WIRE

(71) Applicant: YAZAKI CORPORATION, Tokyo (JP)

(72) Inventor: Kei SATO, Makinohara-shi (JP)

(73) Assignee: YAZAKI CORPORATION, Tokyo (JP)

(21) Appl. No.: 16/446,817

(22) Filed: Jun. 20, 2019

(30) Foreign Application Priority Data
Jul. 23, 2018 (JP) 2018-137568

(51) Int. Cl. H01R 4/18

(52) U.S. Cl. CPC H01R 4/185

(57) ABSTRACT

A terminal metal fitting (20) includes a barrel portion (41) and a contact portion (31). The barrel portion (41) has a plate body to be formed into a tubular shape by overlapping its one end and its other end each other. The plate body has: a base portion (46); a tip portion (45); and an intermediate portion (47) connecting the base portion (46) and the tip portion (45) and to cover a conductor core wire (11) located between the base portion (46) and the tip portion (45). The barrel portion (41) has, at the one end portion of at least the intermediate portion (47) among the plate body, a bent portion (47a) having a bent shape toward the conductor core wire (11) before crimping and to be in pressure contact with the conductor core wire (11) after the crimping.

### CROSS-REFERENCES TO RELATED APPLICATION(S)

This application is based on and claims priority from Japanese Patent Application No. 2018-137568 filed on Jul. 23, 2018, and the entire contents of which are incorporated herein by reference.

### TECHNICAL FIELD

### Field of the Invention

The present invention relates to a terminal metal fitting and a terminal-attached electric wire in which a terminal metal fitting is attached to an electric wire.

### Description of Related Art

In recent years, terminal-attached electric wires in which a terminal metal fitting made of copper or a copper alloy is attached to an electric wire having a conductor core wire made of aluminum or an aluminum alloy (hereinafter referred to as an “aluminum electric wire”) have come to be used in, for example, wire harnesses routed in a vehicle from the viewpoints of weight reduction etc.

For example, in one conventional terminal-attached electric wire using an aluminum electric wire, the surface of a barrel portion of a terminal metal fitting is formed with a fine roughness. When the barrel portion is crimped onto the conductor core wire, an insulative oxide coating that is formed naturally on the surface of the conductor core wire is scraped off by the roughness. As a result, the reliability of the electrical connection between the terminal metal fitting and the conductor core wire is increased (refer to Patent document 1, for example).

As for details of the above terminal-attached electric wire, refer to JP 2013-149598 A.

### SUMMARY

However, in the above conventional terminal-attached electric wire, there may occur an event that the state that the barrel portion is in pressure contact with the conductor core wire satisfactorily due to, for example, repetition of expansion and contraction of the terminal metal fitting or the conductor core wire caused by temperature variations or aging deterioration due to long term use, resulting in loosening of the barrel portion. In that event, the reliability of the electrical connection between the terminal metal fitting and the conductor core wire is lowered because of, for example, reduction of the contact area between them. It is preferable that such reduction of the electrical connection be suppressed to be as small as possible.

An object of the invention is to provide a terminal metal fitting and a terminal-attached electric wire capable of keeping the reliability of the electrical connection between a conductor core wire of an electric wire and the terminal metal fitting at a proper level.

Embodiments of the present invention provide the following items (1) to (5):

(1) A terminal metal fitting to be attached to an electric wire, the terminal metal fitting comprising:

a barrel portion to be crimped onto a conductor core wire exposed from the electric wire; and

a contact portion to be connected to a counterpart terminal,

the barrel portion having a plate body to be formed into a tubular shape after crimping by overlapping one end portion and other end portion of the plate body each other, the plate body having: a base portion to cover a cover body of the electric wire; a tip portion being spaced from the base portion and to cover the conductor core wire; and an intermediate portion connecting the base portion and the tip portion and to cover the conductor core wire located between the base portion and the tip portion to be isolated from outside,

the barrel portion having, at the one end portion of at least the intermediate portion among the plate body, a bent portion having a bent shape toward the conductor core wire before crimping and to be in pressure contact with the conductor core wire after the crimping.

(2) The terminal metal fitting according to the item (1), wherein

the barrel portion has the bent portion at both of the one end portion of the intermediate portion and the one end portion of the tip portion among the plate body.

(3) The terminal metal fitting according to the item (1) or the item (2), wherein

the barrel portion is configured to press, after crimping, an outer surface of the conductor core wire to be recessed inward in radial direction of the conductor core wire by using the bent portion.

(4) The terminal metal fitting according to the item (1) or the item (2), wherein

the barrel portion is configured to bite the bent portion into the conductor core wire after crimping.

(5) A terminal-attached electric wire comprising:

an electric wire; and

the terminal metal fitting according to any one of the item (1) to the item (4), the terminal metal fitting being attached to the electric wire,

the barrel portion of the terminal metal fitting being crimped on the conductor core wire exposed from the electric wire,

the bent portion, at the one end portion of at least the intermediate portion among the plate body, being in pressure contact with the conductor core wire.

According to first aspect of the invention, relating to the item (1), the plate body of the barrel portion is crimped onto the conductor core wire so as to assume a tubular shape because its one end portion and other end portion are laid on each other. Thus, the barrel portion is less prone to loosen by virtue of, for example, frictional force between the one end portion and the other end portion than in the case of the above-described conventional terminal-attached electric wire in which a pair of crimping pieces are crimped so as to merely confront each other.

Furthermore, since the bent portion which is formed in the barrel portion is pressed against the conductor core wire, the internal stress is increased around the bent portion to increase the adhesion to the conductor core wire and the contact area between the terminal metal fitting and the conductor core wire is made wider. Thus, the reliability of the electrical connection is less prone to lower even if the barrel portion loosens to some extent.

In particular, whereas the thickness of a base portion, crimped onto the cover body of an electric wire, of a barrel portion is, in general, about the same as the outer diameter of the electric wire, a tip portion, crimped onto a terminal portion of a conductor core wire, of the barrel portion is, in general, thinner than the tip portion. It is considered that it is usually difficult to bring an intermediate portion, connecting the base portion and the tip portion that are different from each other, of the barrel portion into close contact with the conductor core wire. In contrast, in the terminal metal fitting having the above configuration in which the bent portion is formed in the intermediate portion, the adhesion between the intermediate portion and the conductor core wire is increased, whereby the reliability of the electrical connection of the entire terminal metal fitting is made higher.

Thus, in the terminal metal fitting having the above configuration, the reliability of the electrical connection between the conductor core wire of the electric wire and the terminal metal fitting can be kept at a proper level.

According to second aspect of the invention, relating to the item (2), the bent portion is formed in the tip portion in addition to the intermediate portion. Thus, the reliability of the electrical connection can be kept at a proper level more certainly.

According to third aspect of the invention, relating to the item (3), since the bent portion(s) is shaped so that the outer circumferential surface of the conductor core wire is recessed, the adhesion between the bent portion(s) and the conductor core wire and the contact area are increased. The conductor core wire may be either a bundle of plural element wires or a single wire.

According to fourth aspect of the invention, relating to the item (4), since the bent portion(s) is shaped so as to bite (or stick) into the conductor core wire, the adhesion between the bent portion(s) and the conductor core wire and the contact area are increased. As in item (3), the conductor core wire may be either a bundle of plural element wires or a single wire.

According to fifth aspect of the invention, relating to the item (5), the plate body of the barrel portion is crimped onto the conductor core wire so as to assume a tubular shape because its one end portion and other end portion are laid on each other. Thus, the barrel portion is less prone to loosen by virtue of, for example, frictional force between the one end portion and the other end portion than in the case of the above-described conventional terminal-attached electric wire in which a pair of crimping pieces are crimped so as to merely confront each other.

Furthermore, since the bent portion which is formed in the barrel portion is pressed against the conductor core wire, the internal stress is increased around the bent portion to increase the adhesion to the conductor core wire and the contact area between the terminal metal fitting and the conductor core wire is made wider. Thus, the reliability of the electrical connection is less prone to lower even if the barrel portion loosens to some extent.

In particular, whereas the thickness of a base portion, crimped onto the cover body of an electric wire, of a barrel portion is, in general, about the same as the outer diameter of the electric wire, a tip portion, crimped onto a terminal portion of a conductor core wire, of the barrel portion is, in general, thinner than the tip portion. It is considered that it is usually difficult to bring an intermediate portion, connecting the base portion and the tip portion that are different from each other, of the barrel portion into close contact with the conductor core wire. In contrast, in the terminal-attached electric wire having the above configuration in which the bent portion is formed in the intermediate portion, the adhesion between the intermediate portion and the conductor core wire is increased, whereby the reliability of the electrical connection of the entire terminal-attached electric wire is made higher.

Thus, in the terminal-attached electric wire having the above configuration, the reliability of the electrical connection between the conductor core wire of the electric wire and the terminal metal fitting can be kept at a proper level.

The invention makes it possible to provide a terminal metal fitting and a terminal-attached electric wire capable of keeping the reliability of the electrical connection between a conductor core wire of an electric wire and the terminal metal fitting at a proper level.

Several aspects of the invention have been described briefly above. The further details of the invention will be made clearer if the following description is read through with reference to the accompanying drawings.

### BRIEF DESCRIPTION OF THE DRAWINGS

FIG. 1 is a perspective view of a terminal-attached electric wire according to an embodiment.

FIG. 2A is a perspective view showing how an electric wire is attached to a terminal metal fitting according to the embodiment, and FIG. 2B is a B-B sectional view of FIG. 2A.

FIG. 3A is an A1-A1 sectional view of FIG. 1, FIG. 3B is an A2-A2 sectional view of FIG. 1, and FIG. 3C is an A3-A3 sectional view of FIG. 1.

FIG. 4 is a C-C sectional view of FIG. 3B.

FIG. 5 is a sectional view showing how a pair of crimping pieces of a barrel portion of the terminal metal fitting are swaged using a top die and a bottom die.

FIGS. 6A and 6B are sectional views, corresponding to FIG. 2B and FIG. 3B, respectively, of a terminal metal fitting and a terminal-attached electric wire according to a modification of the embodiment, respectively.

### DETAILED DESCRIPTION

### Embodiment

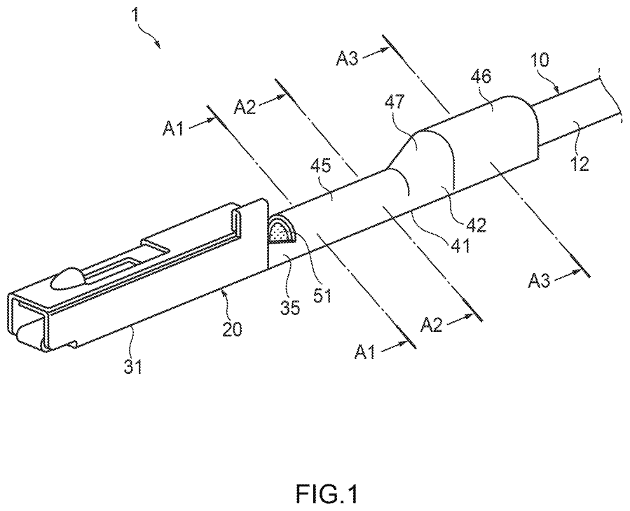

A terminal-attached electric wire 1 in which a terminal metal fitting 20 according to an embodiment of the present invention is attached to an electric wire 10 will be hereinafter described with reference to the drawings. In the following, for convenience of description, in the axial direction (fitting direction) of the terminal metal fitting 20, the side of fitting with a counterpart terminal (not shown), that is, the left side in FIGS. 1, 2A, and 4, will be referred to as a tip side (front side) and the side opposite to it, that is, the right side in FIGS. 1, 2A, and 4, will be referred to as a base side (rear side). Furthermore, the top side and the bottom side are defined as seen in FIGS. 1, 2A, and 4.

As shown in FIGS. 1-4, the terminal metal fitting 20 is crimped on an end portion of the electric wire 10 and thereby electrically connected to a conductor core wire 11 of the electric wire 10. The electric wire 10 and the terminal metal fitting 20 constitute the terminal-attached electric wire 1. For example, the terminal-attached electric wire 1 serves as part of a wire harness that is routed in a vehicle such as an automobile.

The electric wire 10 is an insulated electric wire having the conductor core wire 11 and a resin covering 12 which covers the conductor core wire 11. The conductor core wire 11 is formed by twisting together plural element wires made of aluminum or an aluminum alloy. Since the conductor core wire 11 of the electric wire 10 is made of aluminum or an aluminum alloy, the terminal-attached electric wire 1 is made lighter and hence the wire harness that includes the terminal-attached electric wire 1 is also made lighter. The light terminal-attached electric wire 1 is suitably used, in particular, in vehicles that employ a number of wire harnesses, such as electric vehicles and hybrid vehicles.

The terminal metal fitting 20 has, on the tip side, a contact portion 31 to be connected to the counterpart terminal and, on the base side, a barrel portion 41 to be connected to the conductor core wire 11 of the electric wire 10. The contact portion 31 and the barrel portion 41 are connected to each other by a link portion 35.

The terminal metal fitting 20 is formed by performing press working (punching and bending) on a metal plate (plate body). The terminal metal fitting 20 is made of a different metal material than the conductor core wire 11 is which is made of aluminum or an aluminum alloy. More specifically, the terminal metal fitting 20 is formed using, as a base material, a metal plate (plate body) made of copper or a copper alloy, for example.

To, for example, suppress corrosion of the conductor core wire 11 of the electric wire 10 (i.e., to increase its corrosion resistance), it is preferable to perform plating on the terminal metal fitting 20 after a base metal plate is pressed (punched) and before crimping onto the electric wire 10. In the embodiment, before being crimped onto the electric wire 10, the terminal metal fitting 20 is subjected to tin (Sn) plating. More specifically, a plating layer containing tin is formed on the front surface, the back surface, and the side surfaces formed by the press working.

After being subjected to the surface treatment, the contact portion 31 is formed so as to be shaped like a rectangular pipe having an open tip portion (see FIG. 1). The counterpart terminal is inserted into the open portion of the contact portion 31, whereby the contact portion 31 and the counterpart terminal are electrically connected to each other.

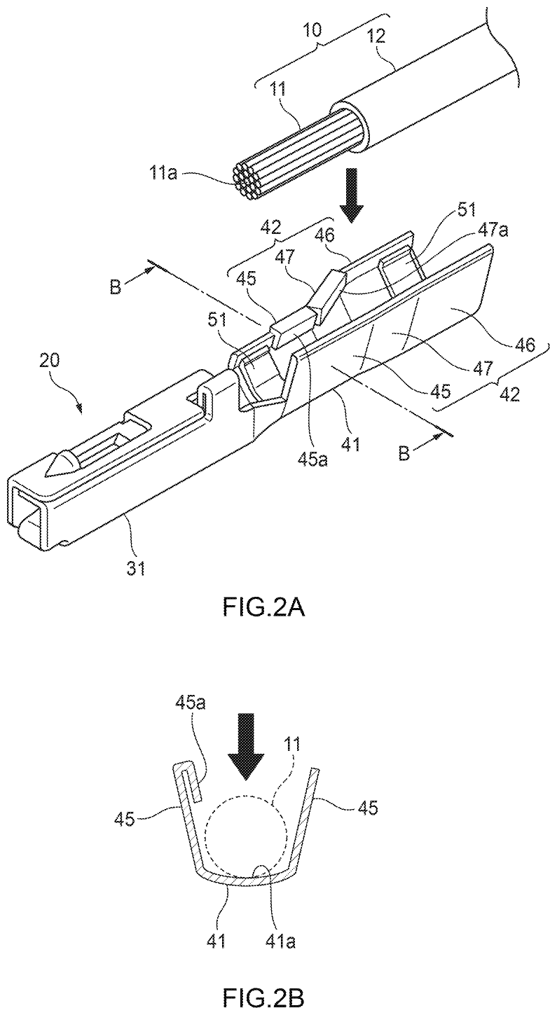

The barrel portion 41 is crimped onto an end portion of the electric wire 10 and thereby electrically connected to it. As shown in FIG. 2A, the barrel portion 41 has a pair of crimping pieces 42. Each crimping piece 42 has a conductor crimping portion 45 on the tip side and a covering crimping portion 46 on the base side. Each crimping piece 42 has a link portion 47 between the conductor crimping portion 45 and the covering crimping portion 46. As such, each crimping piece 42 (conductor crimping portion 45, link portion 47, and covering crimping portion 46) is continuous in the axial direction (fitting direction).

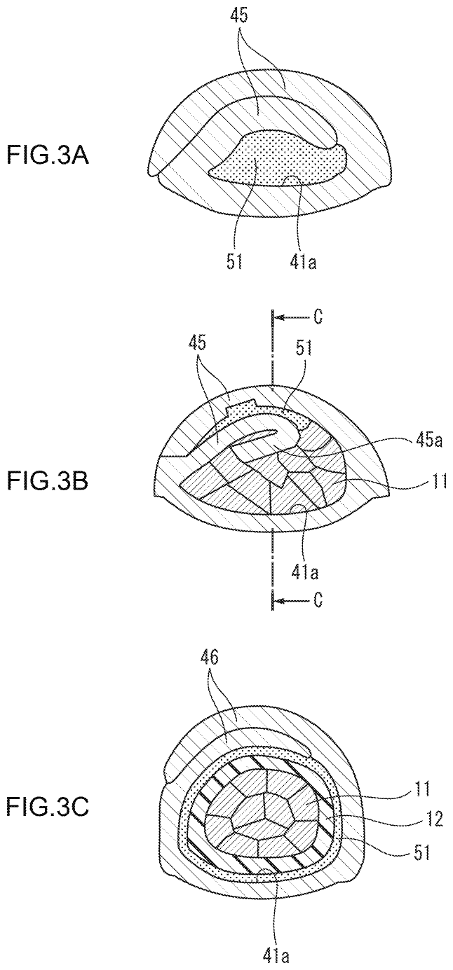

As shown in FIGS. 3A-3C, the pair of crimping pieces 42 are swaged so that an extension end portion of one crimping piece 42 is laid on the inside surface of an extension end portion of the other crimping piece 42 to form an overlap and are thereby crimped onto the end portion of the electric wire 10. In the following, for convenience of description, the one crimping piece 42 and the other crimping piece 42 will also be referred to as an “inside crimping piece 42” and an “outside crimping piece 42,” respectively.

As shown in FIG. 2A, the extension end of the conductor crimping portion 45 of the inside crimping piece 42 is formed with a bent portion 45a that is folded to the side (inside) of contact to the conductor core wire 11 before crimping. Likewise, the extension end of the link portion 47 of the inside crimping piece 42 is formed with a bent portion 47a that is folded to the side (inside) of contact to the conductor core wire 11 before crimping.

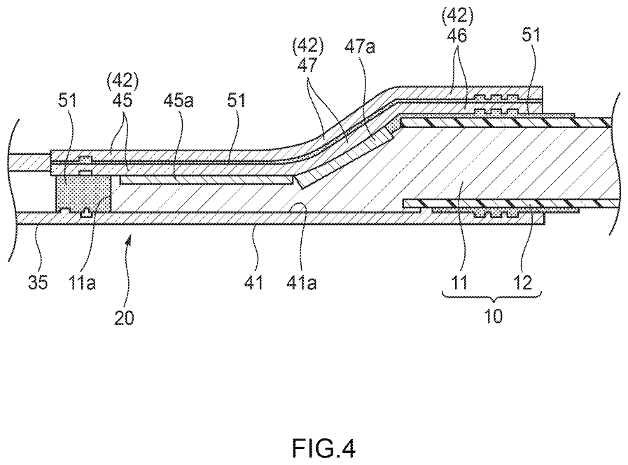

As shown in FIG. 2A, before the crimping, an adhesive 51 is set on the inner surfaces of tip-side portions of the conductor crimping portions 45 and base-side portions of the covering crimping portions 46 so as to extend in the width direction from one extension end to the other extension end. And the adhesive 51 is set on the inner surface of a portion, to be laid on the inside crimping piece 42, of the outside crimping piece 42 so as to extend in the fitting direction from the base-side end to the tip-side end (see FIGS. 3B and 4).

The top surface (inner surface) of a bottom portion of the barrel portion 41 is a mounting surface 41a on which the end portion of the electric wire 10 is to be mounted. In a state that the end portion of the conductor core wire 11 of the electric wire 10 is mounted on the mounting surface 41a (see FIG. 2B), the pair of crimping pieces 42 are swaged so that they surround the end portion of the electric wire 10 and that the extension end portion of the inside crimping piece 42 is laid on the inner surface of the extension end portion of the outside crimping piece 42 to form an overlap.

As a result, as shown in FIGS. 1, 3A-3C, and 4, the conductor crimping portions 45 are crimped onto the conductor core wire 11 of the electric wire 10 and the covering crimping portions 46 are crimped onto the covering 12 of the electric wire 10. That is, the barrel portion 41 having a tubular shape is crimped onto the end portion of the electric wire 10 so that the covering crimping portions 46 cover the conductor core wire 11 of the electric wire 10, the covering crimping portions 46 cover the covering 12 of the electric wire 10, and the link portions 47 cover the conductor core wire 11 so that it is isolated from the outside between the conductor crimping portions 45 and the covering crimping portions 46. In the embodiment, the tip 11a of the conductor core wire 11 of the electric wire 10 is located inside the barrel portion 41 having a tubular shape and is not exposed to the outside.

After the crimping, as shown in FIGS. 3B and 4, the bent portions 45a and 47a are in pressure contact with the conductor core wire 11 of the electric wire 10, whereby portions, pressed by the bent portions 45a and 47a, of the outer circumferential surface of the conductor core wire 11 are recessed inward in the radial direction. Since the bent portions 45a and 47a are pressed against the conductor core wire 11, the internal stress is made stronger around the bent portions 45a and 47a than in a case without the bent portions 45a and 47a, to increase the adhesion to the conductor core wire 11 and the contact area between the terminal metal fitting 20 and the conductor core wire 11 is increased.

After the crimping, as shown in FIGS. 3A-3C and 4, the adhesive 51 fills a tip-side opening portion (see FIG. 3A) of the barrel portion 41 having a tubular shape, a ring-shaped gap between a base-side end portion of the barrel portion 41 and the covering 12 of the electric wire 10 (see FIG. 3C), and the gap between the overlap extension end portions of the pair of crimping pieces 42. As a result, the gaps between the conductor core wire 11 of the electric wire 10 and the outside members are filled up completely by the adhesive 51, whereby entrance of water from outside the barrel portion 41 to the inside of it (i.e., the conductor core wire 11 of the electric wire 10) can be suppressed.

As described above, in the terminal-attached electric wire 1 and the terminal metal fitting 20 according to the embodiment of the invention, the barrel portion 41 is crimped onto the conductor core wire 11 of the electric wire 10 so as to assume a tubular shape because its one extension end portion and other extension end portion are laid on each other. Thus, the barrel portion 41 is less prone to loosen even if it is subjected to temperature variations by virtue of, for example, frictional force between the one extension end portion and the other extension end portion. When the bent portions 45a and 47a of the barrel portion 41 are crimped onto the electric wire 10 of the terminal metal fitting 20, they are brought into pressure contact with the conductor core wire 11, whereby the adhesion between the conductor core wire 11 and the bent portions 45a and 47a is increased. Furthermore, the contact area between the terminal metal fitting 20 and the conductor core wire 11 is made wider than in a case without the bent portions 45a and 47a. Thus, the reliability of the electrical connection is less prone to lower even if the barrel portion 41 loosens to some extent.

In the barrel portion 41 having a tubular shape, the thickness of the covering crimping portions 46, crimped onto the covering 12 of the electric wire 10, of the barrel portion 41 is, in general, about the same as the outer diameter of the electric wire 10 and the conductor crimping portions 45, crimped onto the tip portion of the conductor core wire 11, of the barrel portion 41 are, in general, very thin. Since the covering crimping portions 46 are different in thickness from the conductor crimping portions 45, usually the link portions 47 which are located between them do not easily come into close contact with the conductor core wire 11. In contrast, in the terminal-attached electric wire 1 and the terminal metal fitting 20 according to the embodiment of the invention in which the one link portion 47 is formed with the bent portion 47a, the adhesion between the barrel portion 41 and the conductor core wire 11 can be made high even in the link portions 47.

Thus, the reliability of the electrical connection between the conductor core wire 11 of the electric wire 10 and the terminal metal fitting 20 can be kept high.

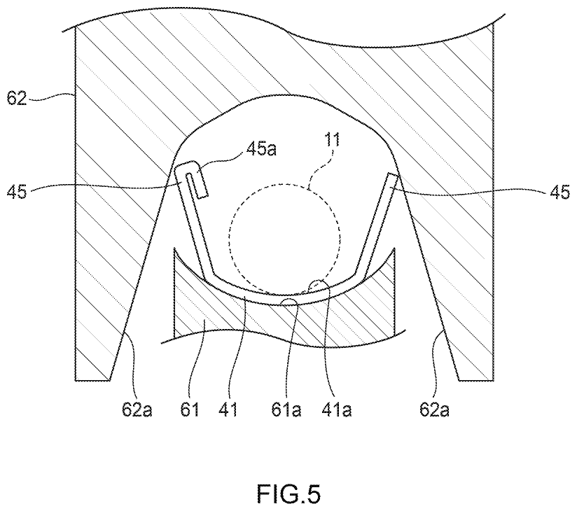

When the pair of crimping pieces 42 of the barrel portion 41 are swaged, usually, a bottom die (anvil) 61 and a top die (crimper) 62 as shown in FIG. 5 are used. More specifically, in a state that the barrel portion 41 in which the end portion of the electric wire 10 is set is supported by a support surface 61a of the bottom die 61, the top die 62 is brought closer to the bottom die 61 and the extension ends of the pair of crimping piece 42 received by guide slant surfaces 62a of the top die 62 are caused to slide on the respective guide slant surfaces 62a, whereby the pair of crimping pieces 42 are swaged.

At this time, since the extension end of the inside crimping piece 42 is formed with the bent portions 45a and 47a, the base-side folding portions of the bent portions 45a and 47a slide on the associated guide slant surface 62a. Thus, even in a case that the barrel portion 41 being supported by the bottom die 61 is inclined around the axial line of the terminal metal fitting 20 in such a direction that the inside crimping piece 42 goes down, the inside crimping piece 42 is easily received by the associated guide slant surface 62a. As a result, the efficiency of work of swaging the pair of crimping pieces 42 of the barrel portion 41 can be made higher than in a case that the bent portions 45a and 47a are not formed (i.e., the extension edge of the inside crimping piece 42 slides on the associated guide slant surface 62a).

### OTHER EMBODIMENTS

The invention is not limited to the above embodiment and various modifications, improvements, etc. can be made as appropriate within the scope of the invention. The materials, shapes, sets of dimensions, numbers, locations, etc. of the respective constituent elements of the above embodiment are not limited to those disclosed but can be determined in desired manners as long as the invention can be implemented.

In the embodiment, as shown in FIG. 2B, before crimping, the extension ends of the conductor crimping portion 45 and the link portion 47 of the inside crimping piece 42 are formed with the respective bent portions 45a and 47a that are folded to the side (inside) of contact to the conductor core wire 11. As a result, as shown in FIG. 3B, after the crimping, the bent portions 45a and 47a are in pressure contact with the conductor core wire 11 of the electric wire 10, whereby portions, pressed by the bent portions 45a and 47a, of the outer circumferential surface of the conductor core wire 11 are recessed inward in the radial direction.

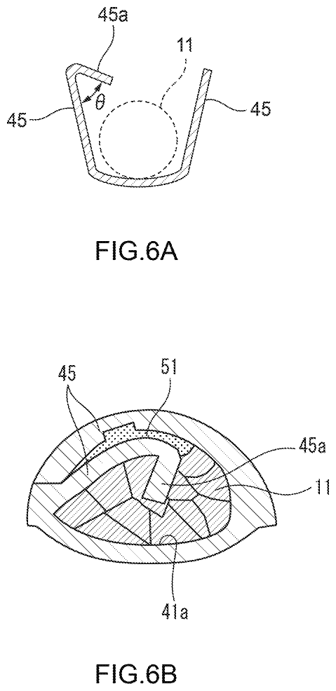

Alternatively, as shown in FIG. 6A, before crimping, the extension ends of the conductor crimping portion 45 and the link portion 47 of the inside crimping piece 42 may be formed with respective bent portions 45a and 47a that are bent at a prescribed angle θ. In this case, as shown in FIG. 6B, after the crimping, the bent portions 45a and 47a bite (stick) into the conductor core wire 11. As a result, as in the embodiment, the adhesion between the conductor core wire 11 and the bent portions 45a and 47a is increased. Furthermore, the contact area between the terminal metal fitting 20 and the conductor core wire 11 is made wider than in a case without the bent portions 45a and 47a. It is preferable that the prescribed angle θ be smaller than or equal to 90° (0<90°). In the embodiment shown in FIGS. 1-4, the prescribed angle θ is substantially equal to 0°.

Furthermore, in the embodiment, the extension end of the conductor crimping portion 45 of the inside crimping piece 42 is formed with the bent portion 45a and the extension end of the link portion 47 of the inside crimping piece 42 is formed with the bent portion 47a. Alternatively, only the extension end of the link portion 47 of the inside crimping piece 42 may be formed with the bent portion 47a.

Still further, in the embodiment, the adhesive 51 is set on the inner surface of the terminal metal fitting 20. However, the adhesive 51 is not an indispensable member and its use may be determined taking into consideration the degree of waterproofness that is required by the terminal metal fitting 20 and the terminal-attached electric wire 1. That is, the terminal-attached electric wire 1 may be constructed by attaching the terminal metal fitting 20 not including the adhesive 51 to the electric wire 10.

Features of the above-described terminal-attached electric wire 1 and terminal metal fitting 20 according to the embodiment of the invention will be summarized below concisely in the form of items [1] to [5]:

[1] A terminal metal fitting (20) to be attached to an electric wire (10), the terminal metal fitting (20) comprising:

a barrel portion (41) to be crimped onto a conductor core wire (11) exposed from the electric wire (10); and

a contact portion (31) to be connected to a counterpart terminal,

the barrel portion (41) having a plate body to be formed into a tubular shape after crimping by overlapping one end portion and other end portion of the plate body each other, the plate body having: a base portion (46) to cover a cover body (12) of the electric wire (10); a tip portion (45) being spaced from the base portion (46) and to cover the conductor core wire (11); and an intermediate portion (47) connecting the base portion (46) and the tip portion (45) and to cover the conductor core wire (11) located between the base portion (46) and the tip portion (45) to be isolated from outside,

the barrel portion (41) having, at the one end portion of at least the intermediate portion (47) among the plate body, a bent portion (47a) having a bent shape toward the conductor core wire (11) before crimping and to be in pressure contact with the conductor core wire (11) after the crimping.

[2] The terminal metal fitting (20) according to item [1], wherein

the barrel portion (41) has the bent portion (45a, 47a) at both of the one end portion of the intermediate portion (47) and the one end portion of the tip portion (45) among the plate body.

[3] The terminal metal fitting (20) according to the item [1] or the item [2], wherein

the barrel portion (41) is configured to press, after crimping, an outer surface of the conductor core wire (11) to be recessed inward in radial direction of the conductor core wire (11) by using the bent portion (45a, 47a).

[4] The terminal metal fitting (20) according to the item [1] or the item [2], wherein

the barrel portion (41) is configured to bite the bent portion (45a, 47a) into the conductor core wire (11) after crimping.

[5] A terminal-attached electric wire (1) comprising:

an electric wire (10); and

the terminal metal fitting (20) according to any one of the items [1] to [4], the terminal metal fitting (20) being attached to the electric wire (10),

the barrel portion (41) of the terminal metal fitting (20) being crimped on the conductor core wire (11),

the bent portion (47a), at the one end portion of at least the intermediate portion (47) among the plate body, being in pressure contact with the conductor core wire (11).

### REFERENCE SIGNS LIST

1: Terminal-attached electric wire
10: Electric wire
11: Conductor core wire
12: Covering (cover body)
20: Terminal metal fitting
31: Contact portion
41: Barrel portion
45: Conductor crimping portion (tip portion)
45a: Bent portion
46: Covering crimping portion (base portion)
47: Link portion (intermediate portion)
47a: Bent portion
51: Adhesive (sealing member)

1. A terminal metal fitting to be attached to an electric wire, the terminal metal fitting comprising:
a barrel portion to be crimped onto a conductor core wire exposed from the electric wire; and
a contact portion to be connected to a counterpart terminal,
the barrel portion having a plate body to be formed into a tubular shape after crimping by overlapping one end portion and other end portion of the plate body each other, the plate body having: a base portion to cover a cover body of the electric wire; a tip portion being spaced from the base portion and to cover the conductor core wire; and an intermediate portion connecting the base portion and the tip portion and to cover the conductor core wire located between the base portion and the tip portion to be isolated from outside,
the barrel portion having, at the one end portion of at least the intermediate portion among the plate body, a bent portion having a bent shape toward the conductor core wire before crimping and to be in pressure contact with the conductor core wire after the crimping.

2. The terminal metal fitting according to claim 1, wherein
the barrel portion has the bent portion at both of the one end portion of the intermediate portion and the one end portion of the tip portion among the plate body.

3. The terminal metal fitting according to claim 1, wherein
the barrel portion is configured to press, after crimping, an outer surface of the conductor core wire to be recessed inward in radial direction of the conductor core wire by using the bent portion.

4. The terminal metal fitting according to claim 1, wherein
the barrel portion is configured to bite the bent portion into the conductor core wire after crimping.

5. A terminal-attached electric wire comprising:
an electric wire; and
the terminal metal fitting according to claim 1, the terminal metal fitting being attached to the electric wire,
the barrel portion of the terminal metal fitting being crimped on the conductor core wire exposed from the electric wire,
the bent portion, at the one end portion of at least the intermediate portion among the plate body, being in pressure contact with the conductor core wire.
